(19) United States
(12) Patent Application Publication
(10) Pub. No.: US 2023/0072982 A1
(43) Pub. Date: Mar. 9, 2023

(54) WARM AIR CHANNEL WITH INTEGRATED HOUSING WALLS

(71) Applicant: Hanon Systems, Daejeon (KR)

(72) Inventors: Eric K. Haupt, Livonia, MI (US); Martin Coleman, Milan, MI (US)

(21) Appl. No.: 17/446,846

(22) Filed: Sep. 3, 2021

(51) Int. Cl. B60H 1/00

(52) U.S. Cl. CPC B60H 1/00542; B60H 1/00528; B60H 1/00521

(57) ABSTRACT

An air-handling housing assembly for a vehicle includes a first housing component having a first lateral wall, a second housing component having a second lateral wall spaced apart from the first lateral wall with a first flow path defined between the first lateral wall and the second lateral wall, and a first wall module received between the first lateral wall and the second lateral wall. The first wall module includes a first engagement portion engaging the first lateral wall, a second engagement portion engaging the second lateral wall, and at least one wall structure extending between the first engagement portion and the second engagement portion for subdividing the first flow path.

### FIELD OF THE INVENTION

The invention relates generally to a heating, ventilating, and air conditioning (HVAC) air-handling system for a motor vehicle, and more particularly, to a housing configuration of the HVAC air-handling system having alignment and assembly features for accommodating multiple flow path housing architectures.

### BACKGROUND OF THE INVENTION

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilation and air conditioning (HVAC) air-handling system. The air-handling system conditions air flowing therethrough and distributes the conditioned air throughout the passenger compartment.

The air-handling system commonly employs a housing having a plurality of conduits and doors for selectively controlling a flow of air to various vents within the passenger compartment of the vehicle, depending on an operating mode selected by a vehicle occupant. Each operating mode includes a preselected percentage of the air originating from a mixing chamber delivered to each of the corresponding vents associated with the selected operating mode. The vents may include panel vents, console vents, front floor vents, rear floor vents, windshield defrost vents, and side window defrost vents, for example.

It has become increasingly common for such air-handling systems to provide a feature wherein the passengers of the motor vehicle can select different temperature settings with respect to two or more different zones within the passenger compartment of the vehicle. For example, many vehicles include independent temperature control for the left and right sides of the passenger compartment, for the front and rear seat zones of the passenger compartment, or for combinations thereof, as desired.

One challenge faced in implementing such independent temperature control relates to the increased complexity of the housing assembly necessary to achieve the independent flow paths necessary for providing the different temperature conditions to the different zones of the passenger compartment. Such housings typically include the stacking of the different flow paths in a direction perpendicular to the general direction of flow of the air through the housing. This typically results in the need to provide multiple layers of parallel arranged walls within an interior of the housing for forming the different flow paths, wherein various components associated with the heating and/or cooling of the air passing through the housing must be distributed between these different flow paths. This can result in the need for the alignment and coupling of multiple different layers of the housing components and the operational components of the air-handling system at interior positions within the housing, which can be particularly challenging with respect to certain configurations of the housing assembly.

For example, FIGS. 1 and 2 illustrate one challenge faced with respect to an exemplary air-handling housing 1 of the prior art. The air-handling housing 1 is shown as being comprised of at least a first outer shell 2, an opposing second outer shell 3, and a dividing structure 4, wherein a first flow path may be formed between the first outer shell 2 and the dividing structure 4 and a second flow path may be formed between the second outer shell 3 and the dividing structure 4. The first outer shell 2 includes a side wall 5 generally arranged parallel to the flow of the air through the housing 1 and at least a first wall segment 6 and a second wall segment 7 projecting laterally from a side wall 5 in a direction perpendicular to the flow of the air through the housing 1. In the example shown in FIG. 1, the first wall segment 6 may define a portion of each of a sealing surface 8 for contacting a corresponding surface of an air control door and a heat exchanger pocket 9 for receiving a heat exchanger therein, while the second wall segment 7 may define a portion of another sealing surface 10 for contacting another downstream arranged air control door. The second outer shell 3 similarly includes a side wall 11 having a first wall segment 12 and a second wall segment 13 projecting laterally therefrom in a direction opposite the wall segments 6, 7 of the first outer shell 2. The dividing structure 4 includes a dividing wall 14 having first wall segments 15, 16 and second wall segments 17, 18 extending from opposing sides thereof.

FIG. 2 illustrates an assembly of the first outer shell 2, the second outer shell 3, and the dividing structure 4 with respect to the portion of the first outer shell 2 bounded by the area A in FIG. 1, which corresponds to a portion of each of the components 2, 3, 4 having the identified wall segments 6, 7, 12, 13, 15, 16, 17, 18. As shown, each of the wall segments 6, 7, 12, 13, 15, 16, 17, 18 is configured to contact an opposing one of the wall segments 6, 7, 12, 13, 15, 16, 17, 18 at a position intermediate a plane defined by each of the adjacent and parallel walls 5, 11, 14. This results in the need to align multiple different free-standing and potentially unstable interior structures of each of the flow paths at positions spaced from a periphery of each of the housing components 2, 3, 4, which is typically where such housing components 2, 3, 4 are coupled to one another. The remoteness of these free-standing structures from the remaining alignment and coupling structures present between the housing components 2, 3, 4 can render such alignment difficult. This problem is especially evident in view of emerging door architectures, such as sliding door architectures used for controlling the flow of the air through at least a portion of the air-handling housing, as various air-directing and sealing surfaces may be in need of alignment with one another.

Accordingly, there exists a need in the art for an HVAC air-handling system housing having improved alignment features for accommodating complex and multiple flow path housing configurations.

### SUMMARY OF THE INVENTION

In accordance and attuned with the present invention, an air-handling system housing having improved alignment features for accommodating complex and multiple flow path housing configurations has surprisingly been discovered.

According to an embodiment of the present invention, an air-handling housing assembly for a vehicle includes a first housing component having a first lateral wall, a second housing component having a second lateral wall spaced apart from the first lateral wall with a first flow path defined between the first lateral wall and the second lateral wall, and a first wall module received between the first lateral wall and the second lateral wall. The first wall module includes a first engagement portion engaging the first lateral wall, a second engagement portion engaging the second lateral wall, and at least one wall structure extending between the first engagement portion and the second engagement portion for subdividing the first flow path.

### BRIEF DESCRIPTION OF THE DRAWINGS

The above, as well as other advantages of the present invention, will become readily apparent to those skilled in the art from the following detailed description of an exemplary embodiment when considered in the light of the accompanying drawings in which:

FIG. 1 is a front elevational view of a first outer shell of an air-handling housing assembly according to the prior art;

FIG. 2 is an exploded fragmentary view showing a method of assembling the portion of the first outer shell bounded by area A in FIG. 1 to corresponding portions of a dividing structure and a second outer shell of the air-handling housing assembly of the prior art;

FIG. 3 is an exploded front elevational view of an air-handling housing assembly according to an embodiment of the present invention;

FIG. 4 is an exploded front right perspective view showing a method of assembling a first wall module and a first outer shell of the air-handling housing assembly;

FIG. 5 is an exploded rear left perspective view showing a method of assembling the first wall module to a dividing structure of the air-handling housing assembly;

FIG. 6 is a rear elevational view of the first wall module and a second wall module in isolation to illustrate a method of coupling the first wall module to the second wall module;

FIG. 7 is an elevational cross-sectional view taken through an assembly of the first outer shell and the first wall module for showing a positioning of the first wall module relative to a heat exchanger and a pair of control doors disposed within the air-handling housing assembly; and

FIG. 8 is an elevational cross-sectional view taken through the assembly of the first outer shell and the first wall module at a position passing through a flow path defined partially by an air-directing channel configured to redirect air through the air-handling housing assembly.

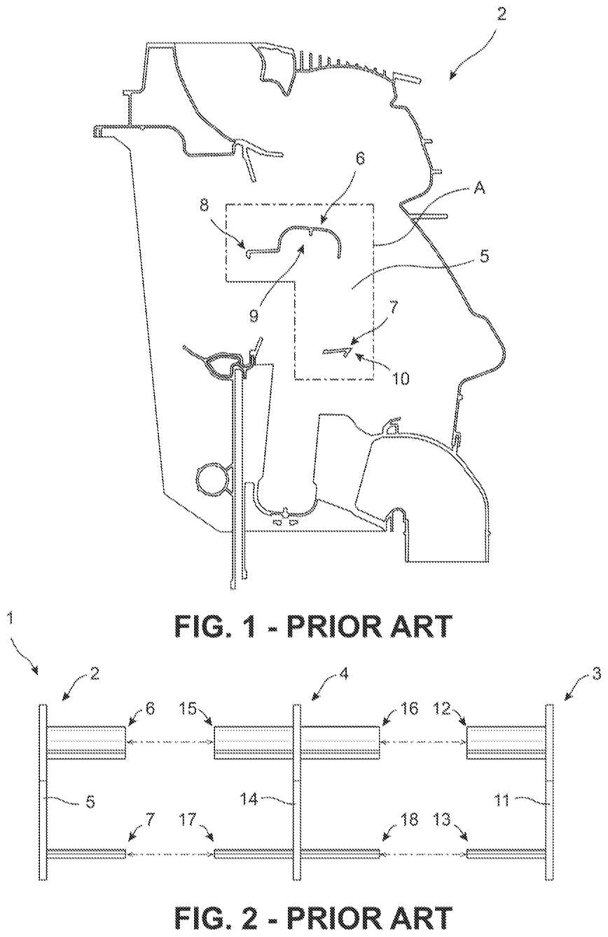

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a similar fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, zones, and/or sections, these elements, components, regions, zones, and/or sections should not be limited by these terms. These terms may be only used to distinguish one element, component, region, zone, or section from another element, component, region, zone, or section. Terms such as “first,” “second,” and other numerical terms when used herein do not imply a sequence or order unless clearly indicated by the context. Thus, a first element, component, region, zone, or section discussed below could be termed a second element, component, region, zone, or section without departing from the teachings of the example embodiments.

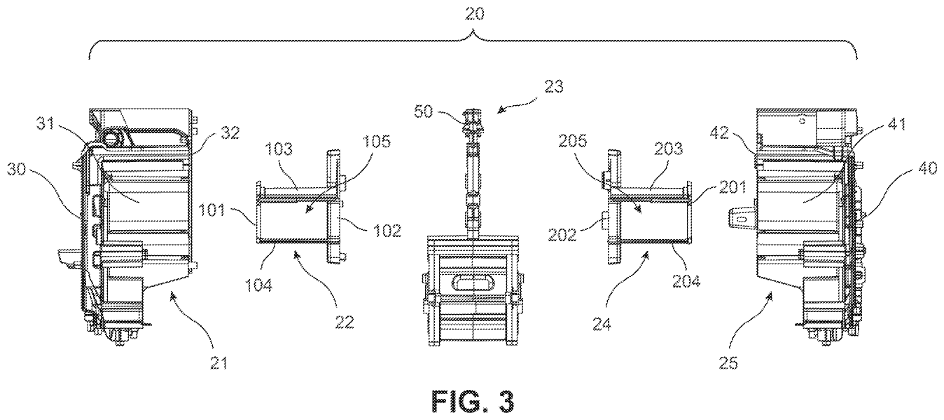

FIGS. 3-8 illustrate an air-handling housing assembly 20 of a heating, ventilating, and air conditioning (HVAC) system or climate control system for a vehicle (not shown) according to an embodiment of the present disclosure. The air-handling housing assembly 20, hereinafter referred to as the housing assembly 20 for brevity, typically provides heating, ventilation, and air conditioning for a passenger compartment (not shown) of the vehicle. The passenger compartment may be divided into a plurality of different zones. The passenger compartment may be divided into front seat and rear seat zones, driver side and passenger side zones, and combinations thereof, as desired.

The housing assembly 20 may accordingly be configured to provide for independent flow and/or temperature control of the air with respect to at least two different zones of the passenger compartment. For example, the housing assembly 20 may be configured to provide at least one of dual zone control, tri-zone control, or quad-zone control. The dual zone control may include independent control of the air directed to each of the front seat zone and the rear seat zone, as desired. The tri-zone control may include the division of the front seat zone into driver side and passenger side zones to allow for independent control of the air directed to each of the front seat driver side zone, the front seat passenger side zone, and the rear seat zone. The quad-zone control may further include the division of the rear seat zone into driver side and passenger side zones to allow for independent control of the air directed to each of the front seat driver side zone, the front seat passenger side zone, the rear seat driver side zone, and the rear seat passenger side zone.

The illustrated housing assembly 20 is comprised of a plurality of housing components 21, 22, 23, 24, 25 coupled to one another for forming at least two distinct flow paths through the housing assembly 20, wherein each of the distinct flow paths may be associated with a flow of air to be delivered to a specific zone or combination of zones of the passenger compartment. The present embodiment of the housing assembly 20 includes a first outer shell 21, a first wall module 22, a dividing structure 23, a second wall module 24, and a second outer shell 25.

The first outer shell 21 includes a lateral wall 30 arranged substantially parallel to a general direction of flow of the air through the housing assembly 20 and a peripheral wall 31 extending from a periphery of the lateral wall 30 in a direction perpendicular to the general direction of flow of the air through the housing assembly 20 and towards the dividing structure 23. As used herein, a lateral direction refers to a direction extending perpendicular to the general direction of flow of the air through the housing 20, hence the peripheral wall 31 may be said to be extending laterally from the lateral wall 30. At least a portion of the peripheral wall 31 terminates at a rim 32, and at least a portion of the rim 32 may be disposed on a plane arranged perpendicular to the lateral direction.

The second outer shell 25 may be substantially symmetric relative to the first outer shell 21 and similarly includes a lateral wall 40 arranged substantially parallel to a general direction of flow of the air through the housing assembly 20 and a peripheral wall 41 extending laterally from a periphery of the lateral wall 40 towards the dividing structure 23. At least a portion of the peripheral wall 41 terminates at a rim 42, and at least a portion of the rim 42 may be disposed on a plane arranged perpendicular to the lateral direction.

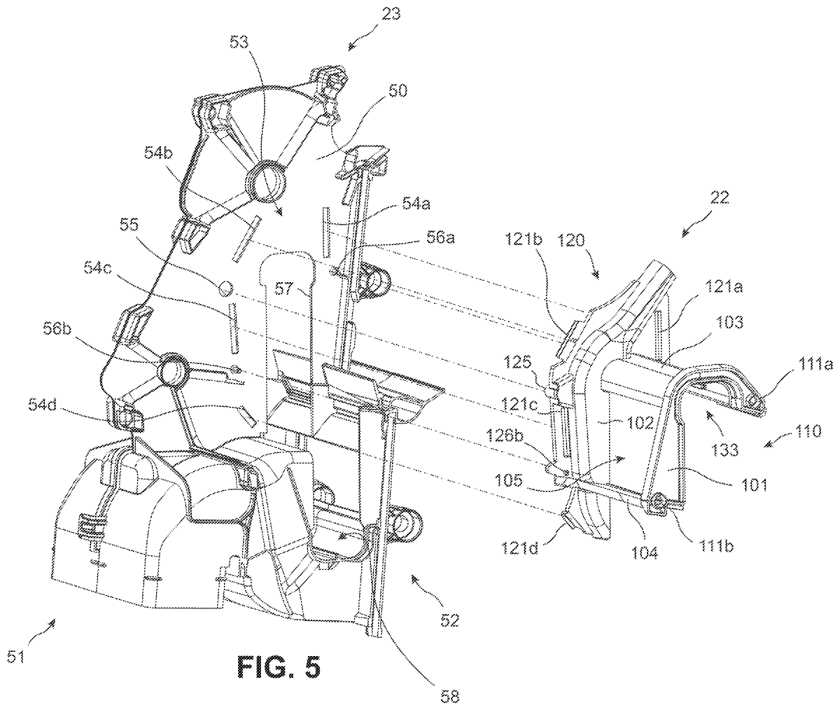

The dividing structure 23 includes a dividing wall 50 arranged substantially parallel to the direction of flow of the air thereby and substantially perpendicular to the lateral direction. The dividing wall 50 forms a boundary between a first flow path and a second flow path formed within the housing assembly 20. Specifically, the first flow path may be formed between the lateral wall 30 and the dividing wall 50, wherein the peripheral wall 31 spaces the lateral wall 30 from the dividing wall 50 with respect to the lateral direction, and the second flow path may be formed between the lateral wall 40 and the dividing wall 50, wherein the peripheral wall 41 spaces the lateral wall 40 from the dividing wall 50. The first flow path accordingly includes a first lateral wall in the form of the lateral wall 30 and a second lateral wall in the form of the dividing wall 50. The second flow path similarly includes a first lateral wall in the form of the lateral wall 40 and a second lateral wall in the form of the dividing wall 50. The dividing wall 50 may accordingly be referred to hereinafter as a lateral wall of the housing assembly 20 by virtue of the dividing wall 50 forming a lateral surface of at least one flow path through the housing assembly 20. As best shown in FIG. 5, the illustrated dividing structure 23 further includes a conduit portion 51 and a sliding door assembly 52 integrated therein and depending from the dividing wall 50, but the dividing structure 23 may include substantially any structure in addition to the dividing wall 50 while remaining within the scope of the present invention, so long as the dividing structure 23 interacts with the first and second wall modules 22, 24 in the manner described herein.

The first outer shell 21 may be configured for coupling to one side of the dividing wall 50 along the rim 32 thereof while the second outer shell 25 may similarly be configured for coupling to an opposing side of the dividing wall 50 along the rim 42 thereof. In other embodiments, the first outer shell 21 may be coupled to the second outer shell 25 along the corresponding rims 32, 42 while the dividing structure 23 may be located between and coupled to the shells 21, 25, as desired. Substantially any configuration may be utilized for coupling the shells 21, 25 and the dividing structure 23 while remaining within the scope of the present invention, so long as each of the identified lateral walls 30, 40 is spaced apart from the dividing wall 50 for forming one of the flow paths through the housing assembly 20.

The first wall module 22 is disposed in a laterally extending space present between the first outer shell 21 and the dividing structure 23 and the second wall module 24 is disposed in a laterally extending space present between the second outer shell 25 and the dividing structure 23. The first wall module 22 includes a first engagement portion 101 formed at a first lateral side thereof, a second engagement portion 102 formed at a second lateral side thereof opposite the first lateral side, and at least one wall structure 103, 104 extending laterally between the first engagement portion 101 and the second engagement portion 102. In the provided example, the at least one laterally extending wall structure 103, 104 includes a first wall structure 103 and a spaced apart second wall structure 104. An opening 105 is formed between and by the cooperation of the engagement portions 101, 102 and the wall structures 103, 104, wherein the opening 105 is configured to allow for the flow of air therethrough when the first wall module 22 is installed within the housing assembly 20 between the first outer shell 21 and the dividing structure 23. The first wall module 22 may include fewer or greater of the laterally extending wall structures while remaining within the scope of the present invention, wherein the number, form, and configuration of the wall structures may be specifically tailored to the flow configurations formed through the corresponding housing assembly 20.

The second wall module 24 similarly includes a first engagement portion 201, an oppositely arranged second engagement portion 202, and at least one laterally extending wall structure in the form of a first wall structure 203 and a spaced apart second wall structure 204, wherein the described second wall module 24 is substantially symmetric relative to the first wall module 22 with respect to a plane defined by the dividing structure 23. The second wall module 24 also defines an opening 205 between and by the cooperation of the engagement portions 201, 202 and the wall structures 203, 204.

Due to the substantially symmetric nature of the housing assembly 20 with respect to the plane defined by the dividing structure 23, only the structure of the interactions present between the assembly of the first outer shell 21, the first wall module 22, and the dividing structure 23 are described in detail hereinafter, wherein it is assumed that the same interactions are present and symmetrically arranged with respect to the assembly of the dividing structure 23, the second wall module 24, and the second outer shell 25, except where noted otherwise hereinafter. Specifically, the first wall module 22 and the second wall module 24 may differ from one another by virtue of mating coupling features present in each of the respective wall modules 22, 24, as explained in detail hereinafter.

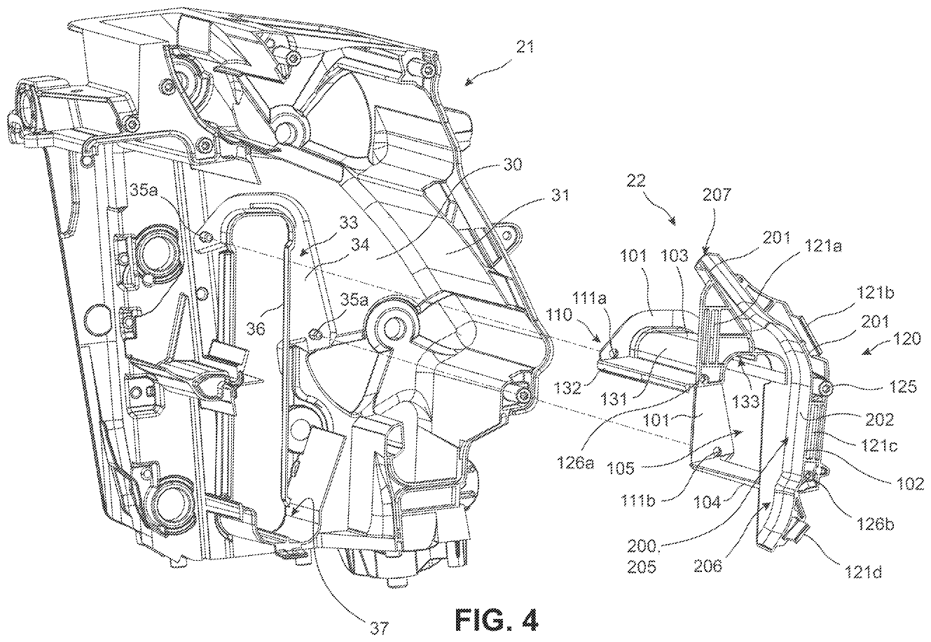

As best shown in FIGS. 4 and 5, the first engagement portion 101 may be substantially planar or plate-like in configuration and may be arranged substantially parallel to the corresponding portion of the lateral wall 30 configured to engage the first engagement portion 101, which corresponds to the first engagement portion 101 being arranged substantially parallel to the flow of the air passing thereby. The first engagement portion 101 is configured to engage the lateral wall 30 forms a positioning feature 110 of the first wall module 22 for properly positioning the first wall module 22 relative to the first outer shell 21 when assembling the housing assembly 20, wherein the positioning feature 110 of the first engagement portion 101 is configured to mate with a corresponding positioning feature 33 of the lateral wall 30 of the first outer shell 21.

The positioning feature 110 of the first engagement portion 101 includes at least a portion of the first engagement portion 101 forming an insertion structure, and the positioning feature 33 of the lateral wall 30 includes a pocket 34 indented laterally into the lateral wall 30 and configured to receive the insertion structure therein. In the present embodiment, the insertion structure is formed by a lateral end portion of the first engagement portion 101 having a peripheral shape corresponding to a peripheral shape of the pocket 34. The insertion structure may be fully or partially received within the pocket 34, as desired. The corresponding peripheral shapes of the insertion structure and the pocket 34 prevent relative rotation and/or translation therebetween when the first wall module 22 is laterally received into the pocket 34 and engaging the lateral wall 30.

The positioning feature 110 of the first engagement portion 101 may further include at least one opening 111a, 111b formed within the first engagement portion 101. In the present embodiment, one of the openings 111a is formed adjacent an intersection of the first engagement portion 101 and the first wall structure 103 while another one of the openings 111b is formed adjacent the intersection of the first engagement portion 101 and the second wall structure 104. The positioning feature 33 of the lateral wall 30 may include a corresponding number of projections 35a 35b extending therefrom, wherein each of the projections 35a, 35b is positioned for alignment with one of the openings 111a, 111b. In the illustrated embodiment, each of the projections 35a, 35b is a pin and each of the openings 111a, 111b is a through-hole receiving one of the pins therein, but alternative mating structures may be utilized without departing from the scope of the present invention. For example, each of the projections 35a, 35b may have alternative shapes and configurations, and each of the openings 111a, 111b may include a corresponding shape for mating with a corresponding one of the projections 35a, 35b, wherein the openings 111a, 111b may be provided as through-holes or indentations having sufficient depth for receiving one of the projections 35a, 35b therein. Each of the projections 35a, 35b may be formed along a portion of the lateral wall 30 including the pocket 34 formed therein, wherein the projections 35a, 35b project from an otherwise recessed area of the lateral wall 30.

The second engagement portion 102 may be substantially planar or plate-like in configuration and may be arranged substantially parallel to the corresponding portion of the dividing wall 50 configured to engage the second engagement portion 102, which corresponds to the second engagement portion 102 being arranged substantially parallel to the flow of the air passing thereby. The second engagement portion 102 is configured to engage the dividing wall 50 and forms a coupling feature 120 of the first wall module 22 for coupling the first wall module 22 to the dividing wall 50 of the dividing structure 23 when assembling the housing assembly 20, wherein the coupling feature 120 of the second engagement portion 102 is configured to mate with a corresponding coupling feature 53 of the dividing wall 50. The coupling feature 120 of the second engagement portion 101 is illustrated as including a variety of different coupling structures, but the coupling feature 120 is not limited to the disclosed configuration. The coupling feature 120 may include any number of the disclosed coupling structures in any combination without necessarily departing from the scope of the present invention, including omitting certain types of the coupling structures, as desired.

The coupling feature 120 is shown as including a plurality of snap-fit connectors 121a, 121b, 121c, 121d distributed about a periphery of the second engagement portion 102. In the provided embodiment, the snap-fit connectors 121a and 121c are provided as female connectors and the snap-fit connectors 121b and 121d are provided as male connectors. Each of the female connectors may include an opening configured to receive a corresponding male connector, and each of the male connectors may extend at least partially in the lateral direction of the housing assembly 20 to facilitate reception of each of the male connectors into a corresponding female connector.

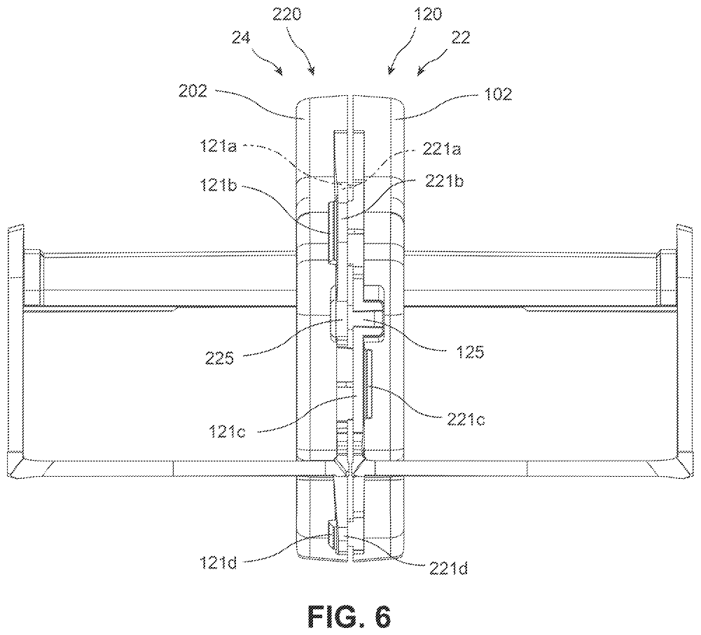

Referring now to FIG. 6, each of the snap-fit connectors 121a, 121b, 121c, 121d of the first wall module 22 may be configured to be coupled to a corresponding snap-fit connector 221a, 221b, 221c, 221d associated with a coupling feature 220 of the second wall module 24. As mentioned above, this mating of the wall modules 22, 24 may result in a deviation from the otherwise symmetric configurations present between the wall modules 22, 24, but the wall modules 22, 24 are otherwise similar in configuration and operation thereof. The coupling feature 53 of the dividing wall 50 may include a plurality of connector openings 54a, 54b, 54c, 54d formed therethrough, wherein each of the connector openings 54a, 54b, 54c, 54d is associated with a corresponding pair of the snap-fit connectors 121a, 121b, 121c, 121d, 221a, 221b, 221c, 221d. For example, the connection of the first wall module 22 to the second wall module 24 may include each of the male snap-fit connectors 121b, 121d of the coupling feature 120 extending through a corresponding connector opening 54b, 54d for reception within a corresponding female snap-fit connector 221b, 221d of the coupling feature 220, and each of the male snap-fit connectors 221a, 221c of the coupling feature 220 extending through a corresponding connector opening 54a, 54c for reception within a corresponding female snap-fit connector 121a, 121c of the coupling feature 120. Any combination of the male and female connectors may be utilized while remaining within the scope of the present invention. Each of the disclosed snap-fit connections may be releasable to allow for the removable coupling of the first wall module 22 to the dividing structure 23.

The manner in which the snap-fit connectors 121a, 121b, 121c, 121d interact with the snap-fit connectors 221a, 221b, 221c, 221d through the dividing wall 50 results in the first wall module 22 being removably coupled to the dividing wall 50 via the coupling feature 120 thereof. Alternatively, if the wall modules 22, 24 are not configured for coupling to each other in the manner shown and described, each of the disclosed connector openings 54a, 54b, 54c, 54d may instead be configured to form a female connector configured for reception of a corresponding male connector of the coupling portion 120, or one or more of the connector openings 54a, 54b, 54c, 54d may be replaced with a projecting male connector structure configured to mate with a corresponding female connector of the coupling portion 120, as desired. The second engagement portion 102 may accordingly be coupled directly to the dividing wall 50 without the need for interaction with the second wall module 24, as desired.

The coupling feature 120 may further include a boss structure 125 configured to receive a fastener (not shown) therethrough. In similar fashion to the snap-fit connectors 121a, 121b, 121c, 121d, the boss structure 125 may be configured for mating with a corresponding boss structure 225 of the second wall module 24, wherein the boss structure 125 forms a male component configured for reception within a female component in the form of the boss structure 225. The boss structures 125, 225 may include aligned apertures to allow for a fastener to be fed therethrough. The boss structure 125 may once again extend laterally through a boss opening 55 formed through the dividing wall 50 to reach the boss structure 225. Alternatively, if the wall modules 22, 24 are not configured for connection through the dividing wall 50, the boss opening 55 may be replaced with structure corresponding to that of the boss structure 225, wherein the first wall module 22 may be configured for connection directly to the dividing wall 50 via reception of an associated fastener through the mating boss structures.

The coupling feature 120 of the second engagement portion 102 may also be considered a positioning feature of the second engagement portion 102 due to the manner in which each of the disclosed coupling structures also positions the first wall module 22 relative to the dividing wall 50. However, the second engagement portion 102 may further include additional positioning structures for forming a positioning feature thereof in addition to the disclosed coupling structures. For example, the second engagement portion 102 is shown as further including at least one opening 126a, 126b formed therein, wherein each of the openings 126a, 126b may be configured for receiving a corresponding projection 56a, 56b extending laterally from the dividing wall 50 therein. Once again, each of the projections 56a, 56b may be a pin and each of the openings 126a, 126b may be a through-hole, although contrary configurations may be utilized, including alternative projection and opening shapes and configurations, as desired. The configuration of the projections and the openings may also be reversed from the disclosed configuration while remaining within the scope of the present invention.

In the provided embodiment, the first wall structure 103 of the first wall module 22 includes an arcuate portion 131 and a linear portion 132 extending from an upstream end of the arcuate portion 131. A concave surface of the arcuate portion 131 may form a component pocket 133 configured to receive at least a portion of a component of the air-handling system associated with the housing assembly 20 therein. In the illustrated embodiment, the lateral wall 30 may further include a component opening 36 formed therein through which the component received within the component pocket 133 may be laterally received into the interior of the housing assembly 20. The pocket 34 may extend around at least a portion of a perimeter of the component opening 36. The lateral wall 30 may further include a component pocket 37 formed at a position opposite the component pocket 133 when the first wall module 22 is assembled to the first outer shell 21 with the component pocket 37 configured to receive an end of the component opposite the end of the component received within the component pocket 133. The dividing wall 50 may also include a component opening 57 formed therethrough for similarly receiving the component in the lateral direction, and the conduit portion 51 and the sliding door assembly 52 of the dividing structure 23 may further cooperate to define another component pocket 58 arranged in lateral alignment with the component pocket 37 of the first outer shell 21.

In the provided embodiment, the component configured for reception within the component openings 36, 57 and pockets 37, 58, 133 may be a heat exchanger forming a portion of the associated HVAC system. The heat exchanger may be a heating heat exchanger, such as a condenser of a refrigerant circuit, a radiator of a cooling system, an electric heating device, or the like, as non-limiting examples, that is configured to selectively increase a temperature of the air passing therethrough (assuming operation of the corresponding heating feature of the heat exchanger). The portion of the housing assembly 20 configured to receive the heat exchanger therein may accordingly be referred to as a warm air zone or region of the housing assembly 20, as air passing through this portion of the housing assembly 20 may be selectively warmed by the heating heat exchanger disposed therein.

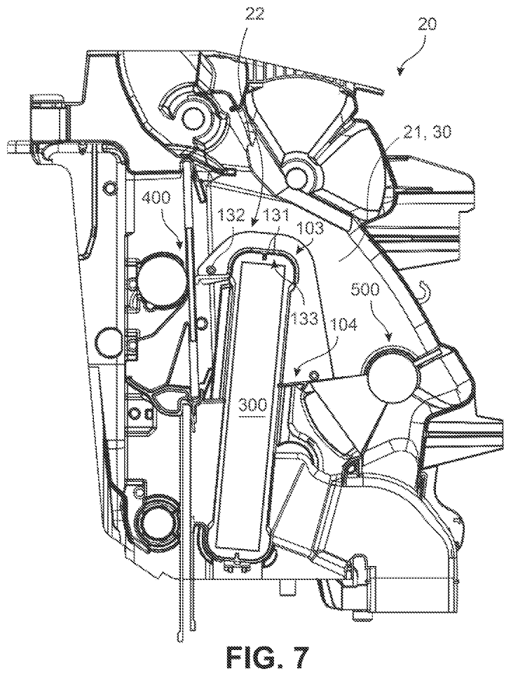

FIG. 7 illustrates a cross-sectional view through the first outer shell 21 and the first wall module 22 of the housing assembly 20 relative to various components of the associated air-handling system in order to better describe the function of each of the wall structures 103, 104 of the first wall module 22. The component pocket 133 as formed by the arcuate portion 131 of the first wall structure 103 forms a heat exchanger pocket for receiving a heating heat exchanger 300 therein. The space occupied by the heating heat exchanger 300 is considered a warm air zone or region of the housing assembly 20. The linear portion 132 of the first wall structure 103 may form a door-engaging surface for engaging a corresponding control door, such as the schematically disclosed sliding door 400 shown in FIG. 7. The sliding door 400 may be configured to determine a distribution of air passing through or bypassing the warm air zone or region formed by the passage through the heating heat exchanger 300. The first wall structure 103 may also form a flow divider within the first flow path, wherein the first wall structure 103 is configured to divide a flow of air encountering the first wall structure 103 into a first partial flow to a first side of the first wall structure 103 and a second partial flow to a second side of the first wall structure 103.

The second wall structure 104 similarly forms a door-engaging surface for engaging another control door, such as the schematically disclosed rotary door 500 shown in FIG. 7. The rotary door 500 may be configured to determine a distribution of air passing to different zones of the passenger compartment. The second wall structure 104 is also disposed at a downstream end of the warm air zone or region as formed by the heating heat exchanger 300 at a position wherein the second wall structure 104 forms a flow divider within the first flow path, wherein the second wall structure 104 is configured to divide a flow of air encountering the second wall structure 104 into a first partial flow to a first side of the second wall structure 104 and a second partial flow to a second side of the second wall structure 104.

Each of the wall structures 103, 104 may accordingly form a flow divider, a flow director, an engaging surface for engaging a moveable component such as a control door, or a locating or positioning feature for locating a component such as the heating heat exchanger 300. The specific functions of each of the wall structures 103, 104 is dependent on the specific structure of the corresponding housing assembly 20.

One or both of the engagement portions 101, 102 may further include an air-directing channel formed therein, wherein each of the air-directing channels is configured to direct air from a first region or zone of the housing assembly 20 to a second region or zone of the housing assembly 20. More specifically, each of the air-directing channels may refer to a flow-directing feature that forms a more direct or linear pathway between the first and second regions or zones of the housing assembly 20 for better distributing the air to different regions or zones of the corresponding passenger compartment.

Referring back to FIGS. 4 and 5, the present embodiment includes an air-directing channel 200 integrated into the structure of the second engagement portion 102 of the first wall module 22, wherein the air-directing channel 200 is provided as a laterally inwardly indented portion of the second engagement portion 102. Specifically, the air-directing channel 200 is formed by a portion of the second engagement portion 102 laterally indented relative to at least one engaging surface 201 thereof, wherein each of the at least one engaging surfaces 201 faces towards and is configured to directly engage the dividing wall 50. The dividing wall 50 and the engaging surfaces 201 of the second engagement portion 102 accordingly include complimentary structure to facilitate each of the engaging surfaces 201 contacting the dividing wall 50 in a manner preventing air from undesirably passing therebetween. In the present embodiment, the complimentary structure includes each of the engaging surfaces 201 as well as the complimentary portion of the dividing wall 50 being planar in configuration, wherein the common plane shared by the engaging surfaces 201 and the dividing wall 50 is arranged parallel to the general direction of flow of the air through the housing assembly 20 and perpendicular to the lateral direction.

The lateral indenting of the second engagement portion 102 along the air-directing channel 200 results in the formation of at least one laterally extending air-directing wall 202 being formed along the air-directing channel 200, wherein each of the air-directing walls 202 extends laterally from an edge of a corresponding one of the engaging surfaces 201. Each of the at least one air-directing walls 202 is configured to redirect air encountering the corresponding air-directing wall 202 in a direction perpendicular to the lateral direction of the housing assembly 200.

When the second engagement portion 102 is placed in engagement with the dividing wall 50, the lateral indenting of the air-directing channel 200 results in the formation of a flow path 205 between the surface of the second engagement portion 102 defining the air-directing channel 200 and the facing surface of the dividing wall 50. The air-directing channel 200 also intersects the perimeter of the second engagement portion 102 at two or more positions therealong to allow for air to enter the flow path 205 and flow between the second engagement portion 102 and the dividing wall 50. In the present embodiment, the air-directing channel 200 includes an inlet 206 disposed to a first side of the first wall structure 103 with respect to a direction arranged perpendicular to the lateral direction and an outlet 207 disposed to a second and opposing side of the first wall structure 103 with respect to the direction arranged perpendicular to the lateral direction. Any air flowing through the flow path 205 accordingly passes from the first side to the opposing second side of the first wall structure 103 while passing through a portion of the wall module 22 disposed laterally to the first wall structure 103.

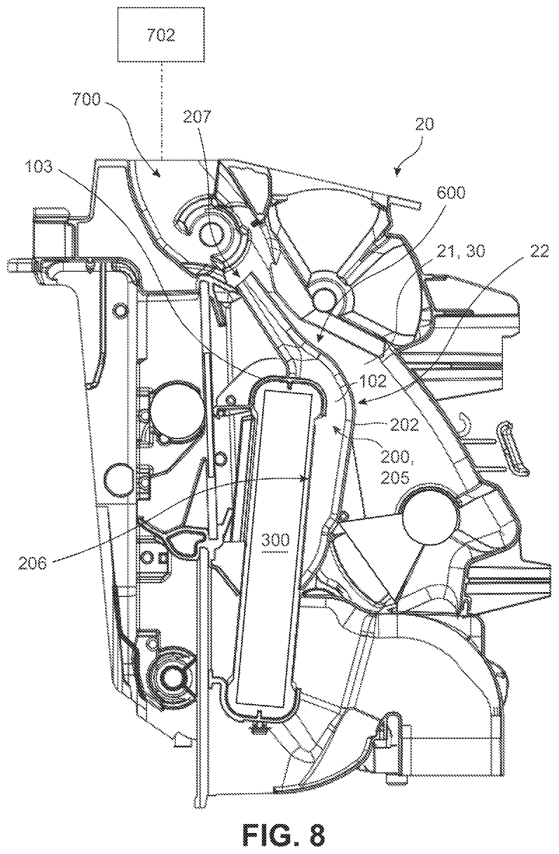

Referring now to FIG. 8, the inlet 206 is shown as being disposed along a downstream end of the heating heat exchanger 300 and the outlet 207 is shown as being disposed within a portion of a delivery section 700 of the housing assembly 20 configured to direct air towards one or more windshield or side window defrost vents 702 of the associated motor vehicle, which is illustrated schematically in FIG. 8. The presence of the air-directing channel 200 within the second engagement portion 102 accordingly allows for air passing through the first flow path defined between the first outer shell 21 and the dividing structure 23 to be divided laterally into a first partial flow passing between the first outer shell 21 and the second engagement portion 102 and a second partial flow passing between the second engagement portion 102 and the dividing wall 50 along the described flow path 205.

As can be seen in FIG. 8, the air-directing channel 200 of the present embodiment is configured to direct the partial flow of air having passed through the heating heat exchanger 300 to bypass a mixing section 600 of the housing assembly 20, hence the flow path 205 may be referred to as the bypass flow path 205. The mixing section 600 of the housing assembly 20 refers to a section where a plurality of different partial air flows that have been independently heated and/or cooled within the housing assembly 20 are rejoined and mixed to achieve a desired temperature and/or pressure of the air being delivered to various different vents of the passenger compartment. For example, the air having passed through the heating heat exchanger 300 to one side of the first wall structure 103 may be mixed with air having bypassed the heating heat exchanger 300 to the opposing side of the first wall structure 103. The bypassing of the mixing section 600 of the housing assembly 20 allows for recently heated air to be directed to a portion of the delivery section 700 having a shortened path to the vents 702, which in the present embodiment are associated with a defrost capability of the associated motor vehicle. This increased distribution of heated and non-mixed air to the delivery section 700 increases a temperature and pressure of the air being delivered to the vents 702 when the defrost capability is requested, which in turn decreases the amount of time necessary to complete the defrosting of the associated windows.

The air-directing channel 200 of the present embodiment may alternatively be referred to as a warm air channel of the housing assembly 20 by virtue of the air-directing channel 200 being positioned specifically to increase a percentage of air reaching the vents 702 that has passed through the heating heat exchanger 300 and selectively been heated therein. It should be apparent from review of FIGS. 4-8 that the air-directing channel 200 may instead be incorporated into the structure of the second engagement portion 102 at a position upstream of the heating heat exchanger 300 such that the air-directing channel 200 bypasses the heating heat exchanger 300 while redirecting air towards a corresponding portion of the delivery section 700 of the housing assembly 20, which may include the air being directed to vents besides the identified defrost vents 702. Assuming the air encountering the air-directing channel 200 has already been cooled within an upstream arranged evaporator or other cooling heat exchanger (not shown) of the housing assembly 20, such an upstream-arranged air-directing channel 200 may instead be referred to as a cool air channel of the housing assembly 20, and may be configured to increase a percentage of cooled air reaching one or more specified vents of the passenger compartment.

The second wall module 24 of the present embodiment also includes a corresponding air-directing channel (not shown) formed therein which is symmetrically arranged relative to the disclosed air-directing channel 200, and operates in the same manner relative to the dividing wall 50, hence further description thereof is omitted. It should also be apparent to one skilled in the art that each of the wall modules 22, 24 may be modified to instead include one of the air-directing channels within either or both of the first engagement portions 101, 201 while remaining within the scope of the present invention. The structure of each of the lateral walls 30, 40 may be modified to correspond to the structure of the corresponding engagement portion 101, 201 for forming the same relationships described herein with regards to the interaction between each of the second engagement portions 102, 202 and the dividing wall 50.

The housing assembly 20 has been shown and described as having a substantially symmetric relationship about the dividing structure 23 with respect to the structure of the wall modules 22, 24, but it should be apparent that the structure of the wall modules 22, 24 and the corresponding lateral walls 30, 40, 50 may be modified to instead include repeating structure with respect to the lateral direction of the housing assembly 20. For example, instead of the dividing wall 50 including similar features on each side thereof, one of the sides of the dividing wall 50 may be modified to include the structure associated with the outer shells 21, 22, while one of the outer shells 21, 22 may be modified to include the structure associated with one of the sides of the dividing wall 50.

It should also be apparent that the structural configurations disclosed herein may also be repeated with respect to housing configurations having more than two laterally spaced apart flow paths formed therethrough, wherein the structure of the lateral walls 30, 40, 50 and the wall modules 22, 24 may be repeated with respect to a stacking of as many of the flow paths as necessary to achieve the desired flow control through the housing assembly 20.

The use of the wall modules 22, 24 in forming a corresponding housing assembly provides numerous benefits over the housing assemblies of the prior art. The manner in which all positioning and coupling features are formed at opposing lateral end portions of each of the wall modules 22, 24 results in the elimination of the need to align free-standing and unstable edges or surfaces within the interior of the housing assembly 20. Instead, each of the wall modules 22, 24 may be positioned or coupled to a corresponding one of the lateral walls 30, 40, 50 prior to the positioning or coupling of the wall module 22, 24 to the other of the facing lateral walls 30, 40, 50, which greatly simplifies the alignment of such features. The manner in which the wall modules 22, 24 may be coupled to each other via one of the lateral walls 50 further simplifies the assembly of the housing components 21, 22, 23, 24, 25 by allowing for the outer shells 21, 25 to be brought together laterally around an assembly of the coupled together wall modules 22, 24 and intervening dividing structure 23. The disclosed configuration also allows for the elimination of discontinuous features within an intermediate portion of each of the flow paths with respect to the lateral direction. The disclosed structure can also be easily repeated with respect to as many different layers of the flow paths for providing independent control to any number of flows of air. Lastly, the use of the wall modules 22, 24 may include air-directing features incorporated therein for achieving a desired flow path for certain partial flows of air through the housing assembly 20, such as partial air flows configured to be delivered to the windows of the associated vehicle during a defrosting function. The incorporation of such air-directing structure into the wall modules 22, 24 further reduces the number of components necessarily in forming the desired flow paths through the housing assembly 20, and further removes another layer of components that must be aligned and axially received in forming the housing assembly 20.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An air-handling housing assembly for a vehicle comprising:
a first housing component having a first lateral wall;
a second housing component having a second lateral wall spaced apart from the first lateral wall, a first flow path defined between the first lateral wall and the second lateral wall; and
a first wall module received between the first lateral wall and the second lateral wall, the first wall module including a first engagement portion engaging the first lateral wall, a second engagement portion engaging the second lateral wall, and at least one wall structure extending between the first engagement portion and the second engagement portion.

2. The air-handling housing assembly of claim 1, further comprising a third housing component having a third lateral wall spaced apart from the second lateral wall and a second wall module received between the second lateral wall and the third lateral wall, wherein the second wall module includes a first engagement portion engaging the third lateral wall, a second engagement portion engaging the second lateral wall, and at least one wall structure extending between the first engagement portion and the second engagement portion thereof, wherein a second flow path is defined between the second lateral wall and the third lateral wall.

3. The air-handling housing assembly of claim 2, wherein the first housing component is a first outer shell, the third housing component is a second outer shell arranged opposite the first outer shell, and the second housing component is a dividing structure disposed between the first outer shell and the second outer shell.

4. The air-handling housing assembly of claim 2, wherein the second engagement portion of the first wall module is coupled directly to the second engagement portion of the second wall module.

5. The air-handling housing assembly of claim 4, wherein at least a portion of the second engagement portion of the first wall module extends through the second lateral wall to contact at least a portion of the second engagement portion of the second wall module.

6. The air-handling housing assembly of claim 5, wherein the at least a portion of the second engagement portion of the first wall module is a male connector and the at least a portion of the second engagement portion of the second wall module is a female connector.

7. The air-handling housing assembly of claim 1, wherein the first lateral wall includes a first positioning feature and the first engagement portion of the first wall module includes a second positioning feature, wherein the first positioning feature is configured to mate with the second positioning feature to position the first wall module relative to the first housing component.

8. The air-handling housing assembly of claim 7, wherein the second lateral wall includes a third positioning feature and the second engagement portion of the first wall module includes a fourth positioning feature, wherein the third positioning feature is configured to mate with the fourth positioning feature to position the first wall module relative to the second housing component.

9. The air-handling housing assembly of claim 7, wherein the second lateral wall includes a first coupling feature and the second engagement portion of the first wall module includes a second coupling feature, wherein the first coupling feature is configured to mate with the second coupling feature to couple the first wall module to the second lateral wall.

10. The air-handling housing assembly of claim 7, wherein the first lateral wall further includes a first coupling feature and the first engagement portion of the first wall module further includes a second coupling feature, wherein the first coupling feature is configured to mate with the second coupling feature to couple the first housing component to the first wall module.

11. The air-handling housing assembly of claim 7, wherein the first positioning feature includes a pocket formed in the first lateral wall and the second positioning feature includes an insertion structure having a shape complimentary to a shape of the pocket, wherein the insertion structure is configured to be inserted into the pocket.

12. The air-handling housing assembly of claim 7, wherein the first positioning feature includes a projection projecting from the first lateral wall and the second positioning feature includes an opening formed in the first engagement portion of the first wall module configured to receive the projection therein.

13. The air-handling housing assembly of claim 1, wherein the first lateral wall includes a first coupling feature and the first engagement portion of the first wall module includes a second coupling feature, wherein the first coupling feature is configured to mate with the second coupling feature to couple the first housing component to the wall module.

14. The air-handling housing assembly of claim 1, wherein the at least one wall structure forms a portion of a pocket for receiving a heat exchanger therein.

15. The air-handling housing assembly of claim 1, wherein the at least one wall structure forms a flow divider for dividing a flow of air through the first flow path.

16. The air-handling housing assembly of claim 1, wherein the at least one wall structure forms an engaging surface for engaging a control door disposed along the first flow path.

17. The air-handling housing assembly of claim 1, wherein the at least one wall structure includes a first wall structure and a spaced apart second wall structure.

18. The air-handling housing assembly of claim 1, wherein a bypass flow path is formed between the second engagement portion and the second lateral wall.

19. The air-handling housing assembly of claim 18, wherein the bypass flow path is at least partially defined by an air-directing channel intended laterally into a surface of the second engagement portion facing towards the second lateral wall.

20. The air-handling housing assembly of claim 18, wherein the bypass flow path directs a flow of air passing therethrough to flow from a first side to an opposing second side of the at least one wall structure while flowing at a position lateral to the at least one wall structure.
